(19) United States
(12) Patent Application Publication
(10) Pub. No.: US 2025/0384723 A1
(43) Pub. Date: Dec. 18, 2025

(54) Smart unlocking technology using UWB angle antenna and iBeacon

(71) Applicant: XTHINGS INDUSTRY LLC, Fremont, CA (US)

(72) Inventor: Lingling Qian, Fremont, CA (US)

(73) Assignee: XTHINGS INDUSTRY LLC, Fremont, CA (US)

(21) Appl. No.: 19/201,338

(22) Filed: May 7, 2025

(51) Int. Cl. G07C 9/00; G01S 5/02; H04B 17/318; H04W 4/80

(52) U.S. Cl. CPC G07C 9/00309; G01S 5/0284; H04B 17/318; H04W 4/80; G07C 2009/00325; G07C 2009/00769

(57) ABSTRACT

A smart unlocking technology using UWB angle antenna and iBeacon; in the present invention, UWB angle antennas are added to a smart lock for communication with iBeacon Bluetooth in the mobile phone, and signal strength detection technology of RSSI is used to effectively determine a distance between the mobile phone and the smart lock, effectively reducing situations of opening the door mistakenly or instability caused by unstable Bluetooth signals in traditional technologies; In addition, the UWB angle antennas have a range judgment of the 120° fan-shaped area within 2 meters; in this way, the recognition effects are maximized within the effective judgment distance, facilitating rapid unlocking in the effective area; the present invention solves problems during users' remote unlocking, and also ensures fast, effective and stable unlocking, which provides a guarantee for the development of smart door locks.

### TECHNICAL FIELD

The present invention relates to the technical field of smart locks, and in particular to a smart unlocking technology using UWB angle antenna and iBeacon.

### BACKGROUND TECHNOLOGY

With the gradual improvement of people's living standards, smart door locks have also entered thousands of households. The smart door locks help people get rid of the original method of manually unlocking with a specific matching key, and existing smart terminals and wireless methods are combined to achieve the function of automatic opening and closing of the lock.

In the prior art, as for some smart door locks, during the wireless communication and unlocking process, after a GPS (Global Positioning System) electronic fence is entered, a specific Bluetooth broadcast is subscribed through an APP in a terminal (such as a mobile phone). After smart door locks connect to a specific Bluetooth, the APP sends an unlocking command. However, the distance for opening the door in this way is uncertain. For example, when the Bluetooth signal is strong in a relatively open area, the door can be opened at a very long distance, resulting in increased insecurity. The instability of the function leads to a poor user experience.

Based on the reasons above, the present invention designs an intelligent unlocking technology using UWB angle antenna and iBeacon, wherein by introducing the UWB angle antenna and iBeacon technology, problems of unstable unlocking and poor safety performance caused by GPS fences and Bluetooth signals being restricted by the scene are effectively avoided, making a wireless smart unlocking mechanism more reasonable, effective and accurate, and greatly improving user experience and reliability of smart door locks.

### SUMMARY OF INVENTION

The purpose of the present invention is to overcome shortcomings of the prior art and provide a smart unlocking technology using UWB (Ultra-Wideband) angle antenna and iBeacon. By introducing the UWB angle antenna and iBeacon technology, problems of unstable unlocking and poor safety performance caused by GPS (Global Positioning System) fences and Bluetooth signals being restricted by the scene are effectively avoided, making a wireless smart unlocking mechanism more reasonable, effective and accurate, and greatly improving user experience and reliability of smart door locks.

In order to achieve the above object, the present invention provides a smart unlocking technology using UWB angle antenna and iBeacon, comprising following steps:
Step 1, using an App (mobile application) in a mobile phone to monitor and enter into a GPS electronic fence area;
Step 2, using the App to establish a connection with an iBeacon Bluetooth;
Step 3, detecting RSSI (Received Signal Strength Indicator) signal strength;
Step 4, if a strength detection result of Step 3 is that RSSI (N+1) is great than RSSI (N) and the result persists, then entering Step 5; if RSSI (N+1) is less than or equal to RSSI (N), then returning to Step 3;
Step 5, turning on UWB angle antennas: using the App in the mobile phone to connect to the UWB angle antennas in the front lock body of a smart lock;
Step 6, detecting position and orientation of the UWB angle antennas;
Step 7, determining whether the UWB angle antennas are within a 120° fan-shaped area within 2 meters directly in a front portion of the mobile phone, if so, entering Step 9; if not, returning to Step 7 to continue the detection; and
Step 8, automatic unlocking.

The UWB angle antennas are a pair, and are symmetrically distributed on a front portion of the front lock body of the smart lock along a position of an NFC symbol.

The RSSI in Step 4 is greater than −65 dBm.

After the automatic unlocking in Step 8, using the App in the mobile phone to subscribe to GPS leaving and waiting for entering into the GPS electronic fence next time.

Compared with the prior art, in the present invention, the UWB angle antennas are added to the smart lock for communication with the iBeacon Bluetooth in the mobile phone, and signal strength detection technology of the RSSI is used to effectively determine a distance between the mobile phone and the smart lock, effectively reducing situations of opening the door mistakenly or instability caused by unstable Bluetooth signals in traditional technologies. In addition, the UWB angle antennas have a range judgment of the 120° fan-shaped area within 2 meters, in this way, the recognition effects are maximized within the effective judgment distance, facilitating rapid unlocking in the effective area.

### DESCRIPTION OF DRAWINGS

FIG. 1 is a schematic diagram of communication between a built-in iBeacon in the mobile phone and UWB angle antennas on a front lock body of a smart lock in the present invention.

FIG. 2 is a communication logic flow chart of the present invention.

FIG. 3 is a communication timing flow chart of the present invention.

### EMBODIMENTS

The present invention will now be further described with reference to the attached drawings.

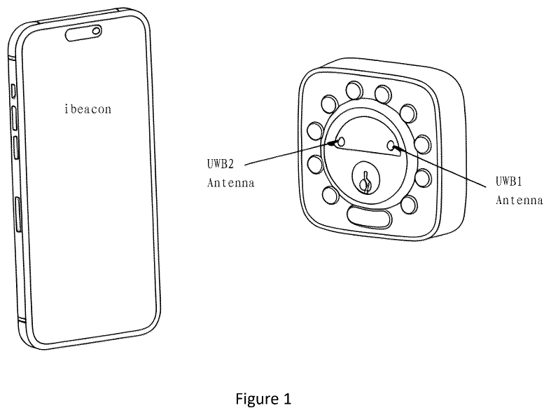

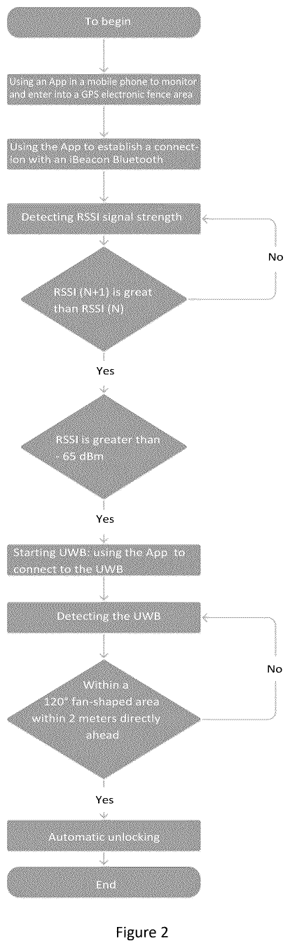

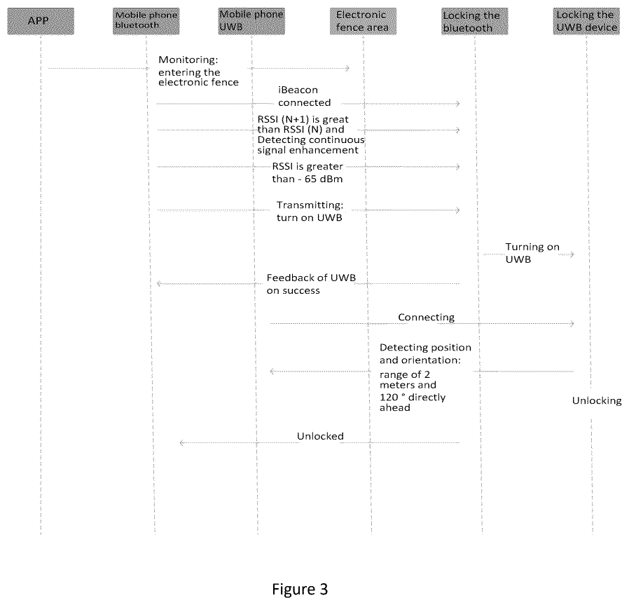

Referring to FIGS. 1 to 3, the present invention provides a smart unlocking technology using UWB (Ultra-Wideband) angle antenna and iBeacon, comprising following steps:
Step 1, using an App (mobile application) in a mobile phone to monitor and enter into a GPS (Global Positioning System) electronic fence area;
Step 2, using the App to establish a connection with an iBeacon Bluetooth;
Step 3, detecting RSSI (Received Signal Strength Indicator) signal strength;
Step 4, if a strength detection result of Step 3 is that RSSI (N+1) is great than RSSI (N) and the result persists, then entering Step 5; if RSSI (N+1) is less than or equal to RSSI (N), then returning to Step 3;
Step 5, turning on UWB angle antennas: using the App in the mobile phone to connect to the UWB angle antennas in the front lock body of a smart lock;
Step 6, detecting position and orientation of the UWB angle antennas;
Step 7, determining whether the UWB angle antennas are within a 120° fan-shaped area within 2 meters directly in a front portion of the mobile phone, if so, entering Step 9; if not, returning to Step 7 to continue the detection; and
Step 8, automatic unlocking.

The UWB angle antennas are a pair, and are symmetrically distributed on a front portion of the front lock body of the smart lock along a position of an NFC symbol.

The RSSI in Step 4 is greater than-65 dBm.

After the automatic unlocking in Step 8, using the App in the mobile phone to subscribe to GPS leaving and waiting for entering into the GPS electronic fence next time.

The above are only preferred embodiments of the present invention, which are only used to help understand the method and core ideas of the present application. The protective scope of the present invention is not limited to the above embodiments. All technical solutions under the concept of the present invention belong to the protective scope of the present invention. It should be pointed out that for ordinary technicians in this technical field, some improvements and modifications without departing from the principle of the present invention should also be regarded as the protective scope of the present invention.

The present invention solves the problem of unstable communication caused by Bluetooth being affected by the scene after entering the GPS electronic fence in the prior art. The UWB angle antennas make accurate distance judgment through signal strength of the RSSI, combined with an induction recognition design, which not only ensures that the user opens the door within the effective distance, but also ensures the accuracy and effectiveness of unlocking. From the perspective of user experience, it greatly improves the convenience of intelligent remote unlocking, solves the user's remote unlocking troubles, and also ensures that the unlocking is fast, effective and stable, providing a guarantee for the development of smart door locks.

1. A smart unlocking technology using UWB angle antenna and iBeacon, comprising following steps:
Step 1, using an App in a mobile phone to monitor and enter into a GPS electronic fence area;
Step 2, using the App to establish a connection with an iBeacon Bluetooth;
Step 3, detecting RSSI signal strength;
Step 4, if a strength detection result of Step 3 is that RSSI (N+1) is great than RSSI (N) and the result persists, then entering Step 5; if RSSI (N+1) is less than or equal to RSSI (N), then returning to Step 3;
Step 5, turning on UWB angle antennas: using the App in the mobile phone to connect to the UWB angle antennas in the front lock body of a smart lock;
Step 6, detecting position and orientation of the UWB angle antennas;
Step 7, determining whether the UWB angle antennas are within a 120° fan-shaped area within 2 meters directly in a front portion of the mobile phone, if so, entering Step 9; if not, returning to Step 7 to continue the detection; and
Step 8, automatic unlocking.

2. The smart unlocking technology using UWB angle antenna and iBeacon according to claim 1, wherein the UWB angle antennas are a pair, and are symmetrically distributed on a front portion of the front lock body of the smart lock along a position of an NFC symbol.

3. The smart unlocking technology using UWB angle antenna and iBeacon according to claim 1, wherein the RSSI in Step 4 is greater than −65 dBm.

4. The smart unlocking technology using UWB angle antenna and iBeacon according to claim 1, wherein after the automatic unlocking in Step 8, using the App in the mobile phone to subscribe to GPS leaving and waiting for entering into the GPS electronic fence next time.
